(19) United States
(12) Patent Application Publication
(10) Pub. No.: US 2026/0243680 A1
(43) Pub. Date: Aug. 20, 2026

(54) SYSTEM FOR ANALYZING PHOTOLUMINESCENCE SIGNAL ON BASIS OF TIME GATE AND OPERATION METHOD THEREOF

(71) Applicant: Korea University Research And Business Foundation, Seoul (KR)

(72) Inventors: Dong June AHN, Seoul (KR); Seok Ho KIM, Seoul (KR); Yong Ho CHO, Seoul (KR)

(73) Assignee: Korea University Research And Business Foundation, Seoul (KR)

(21) Appl. No.: 19/162,546

(22) PCT Filed: Mar. 6, 2024
(86) PCT No.: PCT/KR2024/002833

§ 371 Date: Sep. 5, 2025

(30) Foreign Application Priority Data
Mar. 6, 2023 (KR) 10-2023-0029542
Mar. 4, 2024 (KR) 10-2024-0030955

(51) Int. Cl. G01N 21/64

(52) U.S. Cl. CPC G01N 21/6408; G01N 21/6458

(57) ABSTRACT

A system for analyzing a photoluminescence signal based on time-gating, and a method for operating the system, including an optical microscope configured to magnify and observe a sample specimen using light; a laser light source coupled to one side of a body of the optical microscope and configured to irradiate the sample specimen to be analyzed with a pulsed laser; a detector configured to detect a photoluminescence signal of the sample specimen irradiated with the pulsed laser; and a function generator connected to the laser light source and the detector, and configured to provide a first pulse signal to the laser light source and provide a second pulse signal delayed by a predetermined delay time from the first pulse signal to the detector which detects only a target signal from the photoluminescence signals of the sample specimen and increase the intensity of the detection signal by accumulating the detection signals.

### TECHNICAL FIELD

The present invention relates to a system for analyzing a photoluminescence signal based on time-gating and a method for operating the system.

### BACKGROUND ART

An optical microscope is a device designed to observe objects that cannot be observed with the unaided eye. For example, a user (e.g., a researcher) may observe the crystal structure and morphology of a mineral using the optical microscope. In addition, the optical microscope may be used to analyze the optical properties of living organisms (e.g., cells or tissues). For example, an optical microscope may illuminate a subject (e.g., an organism) with light, detect photoluminescence signals emitted from the irradiated subject, and analyze the optical properties of the subject based on the detected photoluminescence signal.

Meanwhile, organisms may emit autofluorescence signals. These autofluorescence signals may interfere with photoluminescence signals when observing an organism using the optical microscope. For example, when the colors (or wavelength bands) of these signals are identical (or similar), it may be difficult to distinguish between the autofluorescence signal of the organism and the photoluminescence signal that the observer intends to detect. Further, when analyzing the optical properties of the subject, these autofluorescence signals may act as noise.

### SUMMARY OF INVENTION

### Problems to Be Solved by Invention

An object of the present invention is to provide a system for analyzing a photoluminescence signal based on time-gating, which may detect only a target signal (e.g., a phosphorescence signal) from the photoluminescence signals using a time-gating technique and obtain image information and/or spectral information based on the detected target signal, and a method for operating the system.

In addition, another object of the present invention is to provide a system for analyzing a photoluminescence signal based on time-gating, which may accumulate the detected target signals to increase the signal intensity of the target signal, and a method for operating the system.

### Means for Solving Problems

A system for analyzing a photoluminescence signal based on time-gating according to an aspect of the present invention may include: an optical microscope configured to magnify and observe a sample specimen using light; a laser light source coupled to one side of a body of the optical microscope and configured to irradiate the sample specimen to be analyzed with a pulsed laser; a detector configured to detect a photoluminescence signal of the sample specimen irradiated with the pulsed laser; and a function generator connected to the laser light source and the detector, and configured to provide a first pulse signal to the laser light source and provide a second pulse signal delayed by a predetermined delay time from the first pulse signal to the detector.

According to an embodiment, the system may further include a spectrometer configured to separate the photoluminescence signal by wavelength, and record the spectrum of the separated wavelength-specific signal.

According to an embodiment, the photoluminescence signal may include an autofluorescence signal, a fluorescence signal, and a phosphorescence signal of the sample specimen.

According to an embodiment, the detector may generate a time-gated image based on a phosphorescence signal acquired during one cycle of the second pulse signal.

According to an embodiment, the detector may accumulate the time-gated images generated in each cycle of the second pulse signal to generate an accumulated time-gated image.

According to an embodiment, the detector may accumulate phosphorescence signals acquired in each cycle of the second pulse signal, and generate an accumulated time-gated image based on the accumulated phosphorescence signals.

According to an embodiment, the sample specimen may include a hybrid material in which a phosphorescent light-emitting material and a biomaterial are fused.

According to an embodiment, the delay time may be varied based on the lifetimes of the autofluorescence signal, the fluorescence signal, and the phosphorescence signal.

According to an embodiment, the delay time may be greater than a value obtained by adding the larger of the lifetimes of the fluorescence signal and the autofluorescence signal to the pulse width of the first pulse signal, and may be equal to or less than a value obtained by adding the lifetime of the phosphorescence signal to the pulse width of the first pulse signal.

A method for operating a time-gated analysis system according to another aspect of the present invention may include: irradiating a sample specimen with a pulsed laser based on a first pulse signal; detecting a photoluminescence signal of the sample specimen irradiated with the pulsed laser based on a second pulse signal delayed by a predetermined delay time from the first pulse signal; and generating a time-gated image based on the photoluminescence signal detected during one cycle of the second pulse signal.

According to an embodiment, the photoluminescence signal may include an autofluorescence signal, a fluorescence signal, and a phosphorescence signal of the sample specimen.

According to an embodiment, the step of generating a time-gated image may include accumulating time-gated images acquired in each cycle of the second pulse signal to generate an accumulated time-gated image.

According to an embodiment, the step of generating a time-gated image may include accumulating phosphorescence signals acquired in each cycle of the second pulse signal and generating an accumulated time-gated image based on the accumulated phosphorescence signals.

According to an embodiment, the delay time may be varied based on the lifetimes of the autofluorescence signal, the fluorescence signal, and the phosphorescence signal.

According to an embodiment, the delay time may be greater than a value obtained by adding the larger of the lifetimes of the fluorescence signal and the autofluorescence signal to the pulse width of the first pulse signal, and may be equal to or less than a value obtained by adding the lifetime of the phosphorescence signal to the pulse width of the first pulse signal.

According to an embodiment, the method may further include generating spectral information of the photoluminescence signal.

### Advantageous Effects

Various embodiments of the present invention may detect only a target signal (e.g., a phosphorescence signal) from the photoluminescence signals (e.g., fluorescence signals, autofluorescence signals, and/or phosphorescence signals) using a time-gating technique. For example, the present invention may detect only a relatively long-lived phosphorescence signal, while excluding relatively short-lived fluorescence signals and/or autofluorescence signals from the photoluminescence signals using the time-gating technique. Therefore, the present invention may perform biometric recognition functions (e.g., diagnosis of specific diseases) using a hybrid material in which a biomaterial is combined with a phosphorescence-based material.

In addition, the present invention may accumulate the detected target signals (e.g., phosphorescence signals) to increase the intensity of the target signal (or improve augmentation efficiency). In other words, the present invention may improve (i.e., increase) the signal-to-background ratio (SBR) for a time-gated image and improve (i.e., increase) the signal-to-noise ratio (SNR) for a spectrum. Accordingly, the present invention may obtain clear images (e.g., high-resolution images recognizable by the unaided eye) and accurate spectral information.

In addition, the present invention may perform quantitative spectral analysis using the spectral information acquired through a spectrometer. Accordingly, the present invention may overcome the limitations (or problems) of conventional methods that failed to acquire spectral information.

### BRIEF DESCRIPTION OF DRAWINGS

FIG. 1 is a schematic view illustrating a system for analyzing a photoluminescence signal based on time-gating according to an embodiment of the present invention.

FIG. 2A is a view illustrating control signals of the system shown in FIG. 1.

FIG. 2B is a view illustrating an example of accumulating detection signals of the system shown in FIG. 1.

FIG. 3 is a flowchart illustrating a method for operating a system for analyzing a photoluminescence signal based on time-gating according to an embodiment of the present invention.

FIG. 4 is a view illustrating time-gated images of luminescence signals of various phosphorescent materials and autofluorescent materials with respect to delay time according to an embodiment of the present invention.

FIG. 5 is a view illustrating time-gated images and spectra with respect to delay time according to an embodiment of the present invention.

FIG. 6 is a view illustrating an optical image, a non-time-gated image, and a time-gated image of a mixture in which a phosphorescent material and an autofluorescent material are combined (or fused) according to an embodiment of the present invention.

FIG. 7 is a set of views illustrating an optical image, a non-time-gated image, a time-gated image, and a spectrum of autofluorescent cells conjugated with phosphorescent materials according to an embodiment of the present invention.

FIG. 8A is a set of views illustrating changes in time-gated images with frame accumulation according to an embodiment of the present invention.

FIG. 8B is a graph illustrating changes in phosphorescence signal intensity with frame accumulation according to an embodiment of the present invention.

FIG. 8C is a graph illustrating changes in augmentation efficiency with frame accumulation according to an embodiment of the present invention.

### MODE FOR CARRYING OUT INVENTION

The above and other aspects, features, and advantages of the present invention will become apparent from the detailed description of the embodiments to be described below in conjunction with the accompanying drawings. In this regard, it should be understood that the present invention is not limited to the following embodiments and may be embodied in various different forms, and that the embodiments are provided to fully disclose the present invention and to provide a thorough understanding of the present invention to those skilled in the art to which the present invention pertains. The present invention is defined only by the scope of the claims. Hereinafter, the same reference numerals denote the same components.

Although “first,” “second,” and the like may be used to describe various elements, components, and/or sections, these elements, components, and/or sections are not limited by these terms. These terms are merely used to distinguish one element, component, and/or section from another. Therefore, it will be understood that the first element, first component, or first section mentioned below may also be a second element, second component, or second section within the technical spirit of the present invention.

The terminology used herein is for the purpose of describing particular embodiments only and is not intended to limit the present invention. As used herein, the singular forms are intended to include the plural forms as well, unless the context clearly indicates otherwise. It will be further understood that the terms “comprises” and/or “made of,” as used herein, do not preclude the presence or addition of one or more other components, steps, operations, and/or elements in addition to the explicitly recited component, step, operation, and/or element.

Unless otherwise defined, all terms (including technical and scientific terms) used herein have the same meaning as commonly understood by those skilled in the art to which the present invention pertains. Terms defined in commonly used dictionaries are not to be construed in an idealized or overly formal sense unless expressly defined herein.

Hereinafter, the configuration of the present invention will be described in detail with reference to the accompanying drawings.

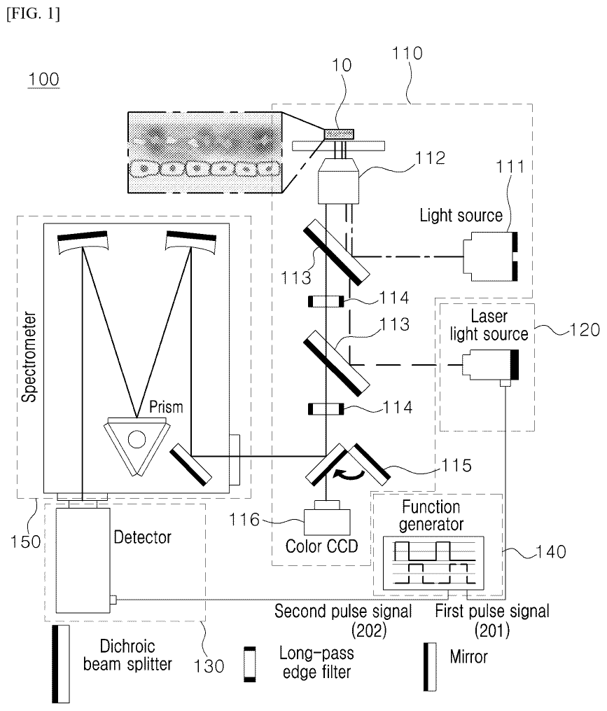

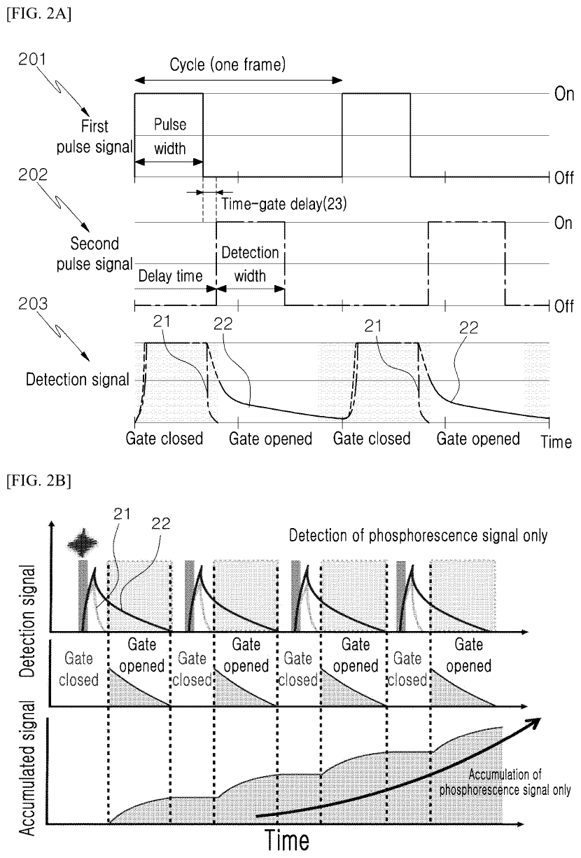

FIG. 1 is a schematic view illustrating a system for analyzing a photoluminescence signal based on time-gating according to an embodiment of the present invention, FIG. 2A is a view illustrating control signals of the system shown in FIG. 1, and FIG. 2B is a view illustrating an example of accumulating detection signals of the system shown in FIG. 1.

Referring to FIGS. 1 to 2B, a system 100 for analyzing a photoluminescence signal based on time-gating (hereinafter, “system”) according to an embodiment of the present invention may include an optical microscope 110, a laser light source 120, a detector 130, a function generator 140, and/or a spectrometer 150.

The optical microscope 110 may magnify a sample specimen 10 using light. The sample specimen 10 may be a material that combines (or fuses) a phosphorescent light-emitting material and a biomaterial. The phosphorescent light-emitting material and the biomaterial may be combined (or fused) through interface design. The phosphorescent light-emitting material (e.g., room-temperature phosphorescence (RTP) material) may include, but is not limited to, a phosphorescent material including a metal atom (e.g., POEP, PdOEP, ZnOEP, Ir(ppy)3, Ir(pmb)3, Ir(fppy)3), a phosphorescent material including a halogen atom (e.g., bromo benzaldehyde, fluorophenyl morpholine (MPh-F), chlorophenyl morpholine (MPh-Cl), iodophenyl morpholine (MPh-I)), or a phosphorescent material composed of organic compounds (e.g., isophthalic acid (IPA), benzophenone). Meanwhile, the biomaterial may include, but is not limited to, deoxyribonucleic acid (DNA)-based materials (e.g., single-stranded DNA, ribonucleic acid (RNA), DNA aptamer, etc.), peptide-based materials (e.g., single-stranded peptide nucleic acid (PNA), PNA aptamer, etc.), or materials capable of specific recognition (sensors) by binding with the biomaterial (e.g., DNA sequence of a specific disease, marker (protein) that may serve as an indicator of a tumor or disease, etc.).

The optical microscope 110 may include, but is not limited to, a light-emitting diode (LED) light source 111, a lens 112, a plurality of dichroic beam splitters 113, a plurality of long-pass edge filters 114, a flip mirror 115, a color charge-coupled device (CCD) 116, and the like. The optical microscope 110 is a generally known device, and thus a detailed description thereof will be omitted.

The laser light source 120 may be coupled to one side of a body (not shown) of the optical microscope 110. The laser light source 120 may irradiate the sample specimen 10 with a pulsed laser. For example, the laser light source 120 may emit a pulsed laser onto the sample specimen 10 in response to a first pulse signal 201 received from the function generator 140. The pulsed laser may have a predetermined wavelength (e.g., 375 nm). The first pulse signal 201 may be, but is not limited to, a pulse width modulation (PWM) signal having a period of 300 ms and a pulse width of 100 ms.

The detector 130 may detect a photoluminescence signal emitted from the sample specimen 10 irradiated with the pulsed laser. The detector 130 may be, but is not limited to, an electron-multiplying charge-coupled device (EMCCD) detector. According to an embodiment, the detector 130 may detect a photoluminescence signal in response to a second pulse signal 202 received from the function generator 140. The photoluminescence signal may include a fluorescence signal (and/or an autofluorescence signal) 21 and a phosphorescence signal 22. The second pulse signal 202 may be a signal delayed by a predetermined time (hereinafter, delay time) (e.g., 100.5 ms) independent of the first pulse signal 201. Meanwhile, the difference (e.g., 0.5 ms=100.5 ms−100 ms) between the delay time (e.g., 100.5 ms) and the pulse width of the first pulse signal 201 (e.g., 100 ms) may be referred to as a time-gate delay (TG delay) 23.

Due to the delay time and/or time-gate delay, the detection signal 203 detected by the detector 130 may have a time-gated form, as shown in FIG. 2A. That is, the detector 130 may detect only the phosphorescence signal 22 among the photoluminescence signals. The detector 130 may generate a time-gated image based on the phosphorescence signal acquired during one cycle. In addition, the detector 130 may accumulate the phosphorescence signals acquired in each cycle, as shown in FIG. 2B, and generate an accumulated (or augmented) time-gated image based on the accumulated phosphorescence signals. Alternatively, the detector 130 may generate an accumulated time-gated image by accumulating frames (e.g., time-gated images generated in each cycle).

The function generator 140 may generate a pulse signal. The pulse signal may be a pulse width modulation (PWM) signal. For example, the function generator 140 may generate the first pulse signal 201 to provide (transmit) it to the laser light source 120, and generate the second pulse signal 202 to provide (transmit) it to the detector 130. The second pulse signal 202 may be a signal obtained by delaying the first pulse signal 201 by a predetermined delay time. A time-gate delay 23 may be varied depending on the lifetime of the phosphorescence signal 22 and the noise signal (e.g., the fluorescence signal (and/or autofluorescence signal) 21) to be excluded.

The spectrometer 150 may be coupled to the detector 130. The spectrometer 150 may separate the photoluminescence signals by wavelength, and record (or measure) the spectra of the separated wavelength-specific signals. For example, the spectrometer 150 may separate the photoluminescence signals into the fluorescence signal (or autofluorescence signal) 21 and the phosphorescence signal 22, and record (or measure) the spectra of the fluorescence signal 21 and the phosphorescence signal 22. The spectrometer 150 may include a plurality of mirrors for changing the propagation direction of the luminescence signal and a prism for spectrally dispersing the photoluminescence signals. Meanwhile, when the spectral information is not generated, the spectrometer 150 may not be included in the system 100.

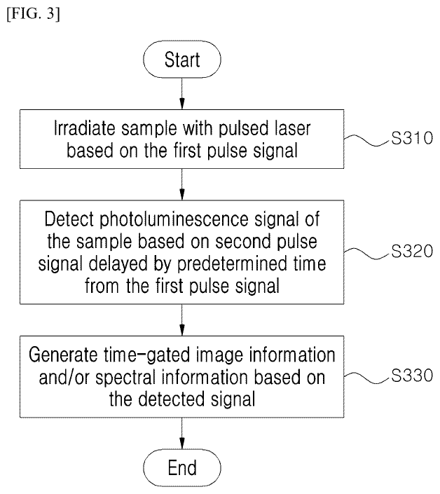

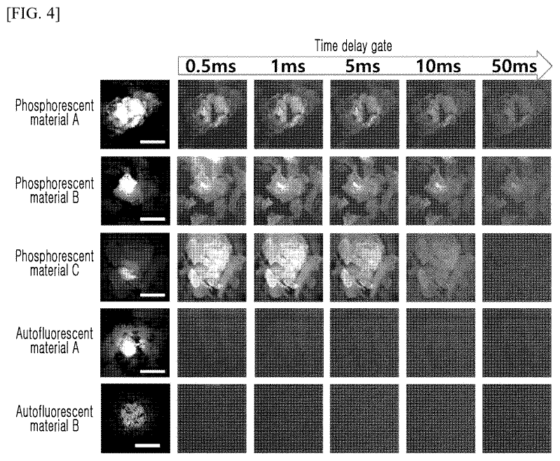

FIG. 3 is a flowchart illustrating a method for operating a system for analyzing a photoluminescence signal based on time-gating according to an embodiment of the present invention.

Referring to FIG. 3, a method for operating the system for analyzing a photoluminescence signal based on time-gating (hereinafter, “method”) according to an embodiment of the present invention may include a step (S310) of irradiating a sample specimen with a pulsed laser based on a first pulse signal. For example, the laser light source 120 of the system 100 shown in FIG. 1 may irradiate the sample specimen 10 with a pulsed laser based on the first pulse signal 201 received from the function generator 140.

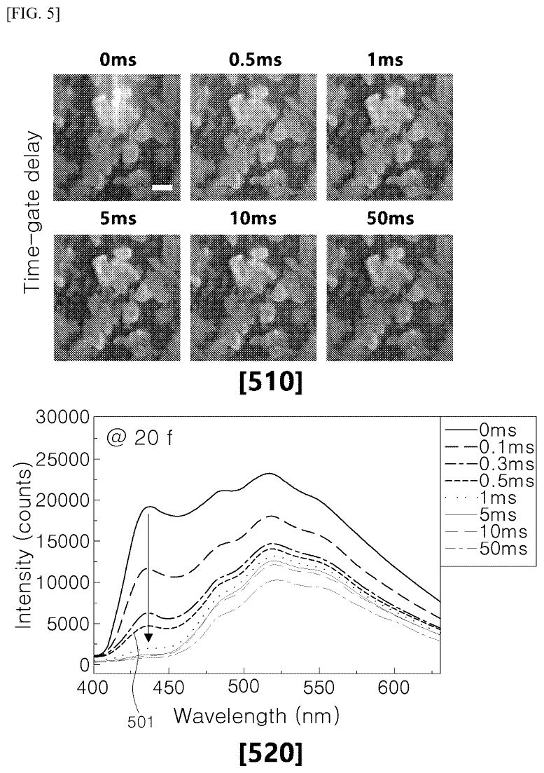

The method may include a step (S320) of detecting a photoluminescence signal of a sample specimen based on a second pulse signal obtained by delaying the first pulse signal by a predetermined delay time. For example, the detector 130 of the system 100 shown in FIG. 1 may detect a portion of the photoluminescence signal of the sample specimen 10 (e.g., a signal having a relatively long lifetime, such as a phosphorescence signal) while the second pulse signal is on. Meanwhile, the delay time may be determined so that the fluorescence signal (or autofluorescence signal) is not detected and only the phosphorescence signal is detected. In other words, the delay time may be set based on the lifetimes of the fluorescence signal (or autofluorescence signal) and the phosphorescence signal. A detailed description thereof will be provided below with reference to FIGS. 4 and 5.

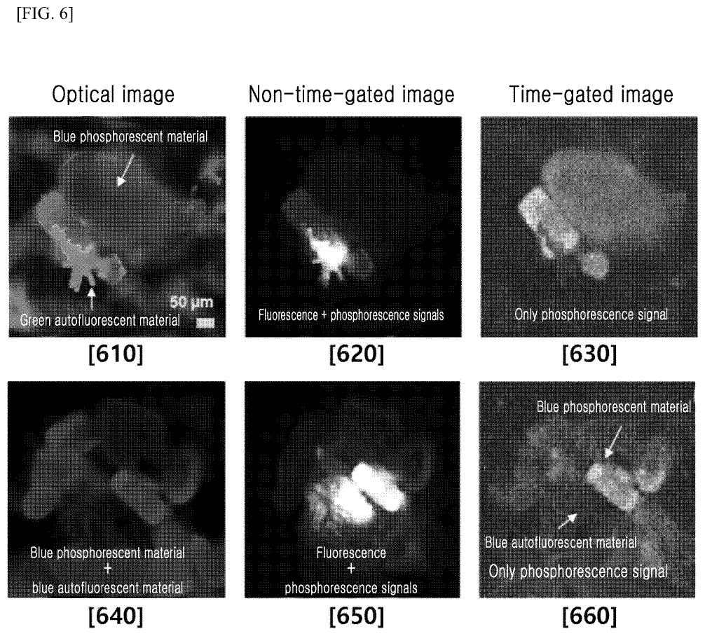

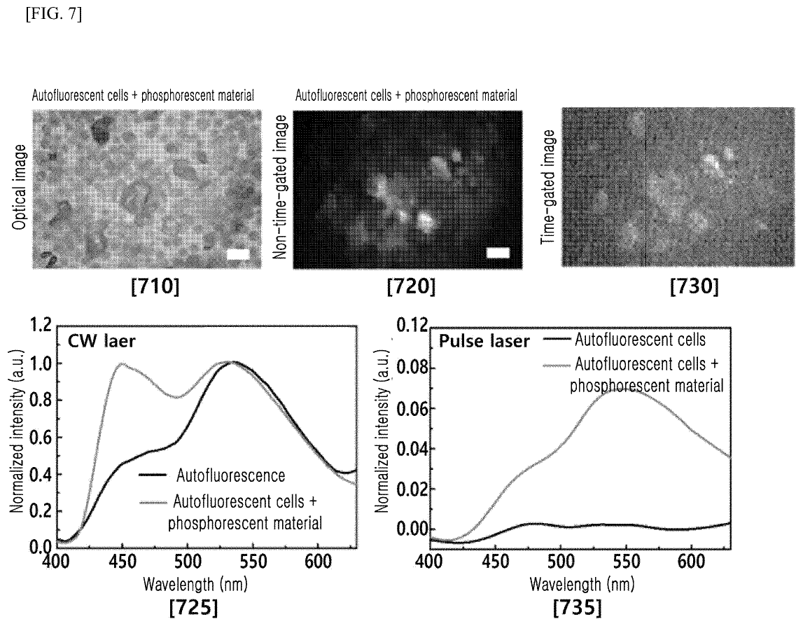

The method may include a step (S330) of generating a time-gated image and/or spectral information based on the detected detection signal. For example, the detector 130 of the system 100 shown in FIG. 1 may generate a time-gated image based on the detection signal detected during one cycle. In addition, the detector 130 may generate spectral information based on the spectrum of the photoluminescence signal separated and recorded (measured) by the spectrometer 150 according to wavelength. A detailed description thereof will be provided below with reference to FIGS. 6 and 7.

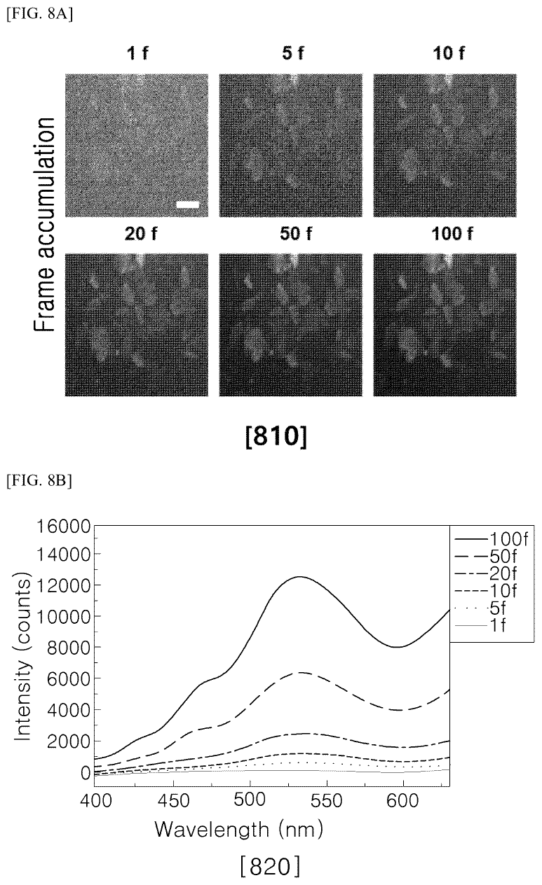

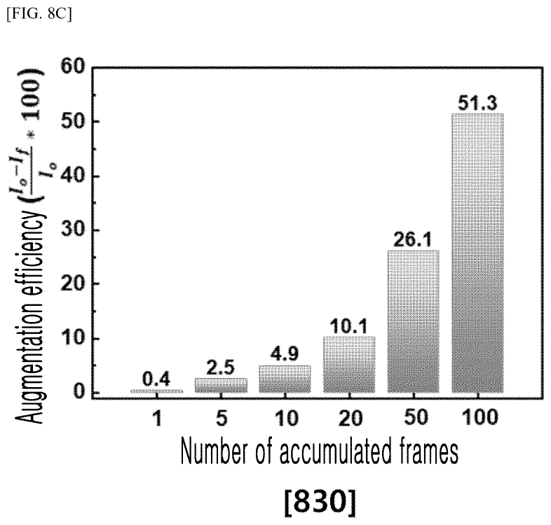

According to an embodiment, the detector 130 may accumulate detection signals detected in each cycle and generate an accumulated time-gated image based on the accumulated signals. In addition, the detector 130 may generate spectral information based on the accumulated signals. Alternatively, the detector 130 may accumulate the spectral information of photoluminescence signals recorded (measured) by the spectrometer 150 in each cycle to generate accumulated spectral information. A detailed description thereof will be provided below with reference to FIG. 8.

FIG. 4 is a view illustrating time-gated images of luminescence signals of various phosphorescent materials and autofluorescent materials with respect to delay time according to an embodiment of the present invention, and FIG. 5 is a view illustrating time-gated images and spectra with respect to delay time according to an embodiment of the present invention.

Referring to FIGS. 4 and 5, it can be seen that the detector 130 of the system according to an embodiment of the present invention may detect the phosphorescence signals of phosphorescent material A (e.g., DBP), phosphorescent material B (e.g., pDBP), and phosphorescent material C (e.g., Phe-DITFB), but may not detect the autofluorescence signals of autofluorescent material A (e.g., Trp) and autofluorescent material B (e.g., Rf). In addition, it can be seen that the detector 130 of the system 100 may detect the phosphorescence signals of phosphorescent material A and phosphorescent material B up to the time-gate delay 23 of 50 ms, and may detect the phosphorescence signal of phosphorescent material C up to the time-gate delay 23 of 10 ms. Therefore, it can be seen that the lifetime of the phosphorescence signal of phosphorescent material C is shorter than the lifetimes of the phosphorescence signals of phosphorescent material A and phosphorescent material B.

The delay time of the second pulse signal 202 in FIG. 2A may be set according to the lifetime of the target signal (e.g., the phosphorescence signal) and the signal to be excluded (e.g., the fluorescence signal and/or the autofluorescence signal). Taking as an example the measurement of one cycle consisting of the first pulse signal 201, the delay time, and the second pulse signal 202, the maximum value of the delay time may be determined to be equal to or less than the pulse width of the first pulse signal 201 plus the lifetime of the target signal (e.g., the phosphorescence signal). This is because when the lifetime of the target signal has elapsed, the target signal can no longer be detected. On the other hand, the minimum value of the delay time may be determined to be greater than the pulse width of the first pulse signal 201 plus the lifetime of the signal to be excluded (e.g., the fluorescence signal and/or the autofluorescence signal). For example, when the pulse width of the first pulse signal 201 is 100 ms, the lifetime of the signal to be excluded is 0.4 ms, and the lifetime of the target signal is 50 ms, the delay time may be greater than 100.4 ms (=100 ms+0.4 ms) and equal to or less than 150 ms (=100 ms+50 ms).

According to an embodiment, the minimum value of the delay time may be determined as a value obtained by adding the pulse width of the first pulse signal to a time-gate delay (e.g., 0.5 ms) at which the signal to be excluded begins not to be detected, among a plurality of time-gate delays, as shown in the images of reference numeral 510 in FIG. 5. Alternatively, the minimum value of the delay time may be determined as a value obtained by adding the pulse width of the first pulse signal to a time-gate delay (e.g., 0.5 ms) corresponding to the graph 501 among the graphs showing the change in intensity of the luminescence signal with respect to the change in delay time, as indicated by reference numeral 520 of FIG. 5, where the intensity of the signal in the wavelength band of the signal to be excluded begins to fall below a predetermined value (e.g., a value close to “()”).

FIG. 6 is a view illustrating an optical image, a non-time-gated image, and a time-gated image of a mixture in which a phosphorescent material and an autofluorescent material are combined (or fused) according to an embodiment of the present invention, and FIG. 7 is a set of views illustrating an optical image, a non-time-gated image, a time-gated image, and a spectrum of autofluorescent cells conjugated with phosphorescent materials according to an embodiment of the present invention.

Referring to FIGS. 6 and 7, when observing the photoluminescence signal of a mixture in which a blue phosphorescent material (e.g., isophthalic acid (IPA)) and a green autofluorescent material (e.g., riboflavin) are combined (or fused) through an optical microscope, the color CCD 116 of the optical microscope 110 may generate an optical image including autofluorescence and phosphorescence signals, as shown in the optical image of reference numeral 610 in FIG. 6. At this time, a user may distinguish the autofluorescence signal and the phosphorescence signal through color. Meanwhile, when observing the photoluminescence signal of the mixture through a conventional detector without time-gating, the conventional detector may detect both the autofluorescence signal and the phosphorescence signal, as shown in the non-time-gated image of reference numeral 620 in FIG. 6. At this time, the autofluorescence signal may act as noise with respect to the phosphorescence signal, which is the target signal. In contrast, the time-gated detector 130 according to the present invention may detect only the phosphorescence signal, excluding the autofluorescence signal, as shown in the time-gated image of reference numeral 630 in FIG. 6.

As another example, when observing the photoluminescence signal of a mixture of a blue phosphorescent material (e.g., isophthalic acid (IPA)) and a blue autofluorescent material (e.g., tryptophan) through an optical microscope, the color CCD 116 of the optical microscope 110 may generate an optical image including autofluorescence and phosphorescence signals, as shown in the optical image of reference numeral 640 in FIG. 6. At this time, since the wavelength bands of the autofluorescence signal and the phosphorescence signal are similar, it may be difficult for the user to distinguish the autofluorescence signal and the phosphorescence signal from the optical image. Meanwhile, the conventional detector may detect both the autofluorescence signal and the phosphorescence signal, as shown in the non-time-gated image of reference numeral 650 in FIG. 6. At this time, the autofluorescence signal may act as noise with respect to the phosphorescence signal, which is the target signal. In contrast, the time-gated detector 130 according to the present invention may detect only the phosphorescence signal, excluding the autofluorescence signal, as shown in the time-gated image of reference numeral 660 in FIG. 6. In this way, the present invention may detect only the target signal (e.g., the phosphorescence signal) even when the emission wavelength bands are the same (or similar) and it is difficult to distinguish them with the unaided eye (optical microscope) or the conventional detector.

As another example, when observing autofluorescent cells combined with a phosphorescent material through an optical microscope, the color CCD 116 of the optical microscope 110 may generate an optical image including the autofluorescence signal of the autofluorescent cells and the phosphorescence signal of the phosphorescent material, as shown in the optical image of reference numeral 710 in FIG. 7. Meanwhile, a conventional detector may detect both the autofluorescence signal and the phosphorescence signal, as shown in the non-time-gated image of reference numeral 720 in FIG. 7 and the spectrum of reference numeral 725 in FIG. 7. At this time, the autofluorescence signal may act as noise with respect to the phosphorescence signal, which is the target signal. On the other hand, the time-gated detector 130 according to the present invention may detect only the phosphorescence signal, excluding the autofluorescence signal, as shown in the time-gated image of reference numeral 730 in FIG. 7 and the spectrum of reference numeral 735 in FIG. 7.

FIG. 8A is a set of views illustrating changes in time-gated images with frame accumulation according to an embodiment of the present invention, FIG. 8B is a graph illustrating changes in phosphorescence signal intensity with frame accumulation according to an embodiment of the present invention, and FIG. 8C is a graph illustrating changes in augmentation efficiency with frame accumulation according to an embodiment of the present invention.

Referring to FIGS. 8A to 8C, the system 100 according to an embodiment of the present invention may accumulate frames acquired in each cycle (e.g., time-gated images measured in each cycle). At this time, as shown in the images of reference numeral 810 in FIG. 8A and the graph of reference numeral 820 in FIG. 8B, as the number of accumulated frames increases, the intensity of the phosphorescence signal also increases, thereby facilitating the identification of the phosphorescence signal. In addition, as shown in the graph of reference numeral 830 in FIG. 8C, it can be seen that the augmentation efficiency of the phosphorescence signal increases as the number of accumulated frames increases.

The present invention, as described above, may detect only a relatively long-lived phosphorescence signal, while excluding relatively short-lived fluorescence signals and/or autofluorescence signals from the photoluminescence signals using the time-gating technique. Therefore, the present invention may perform biometric recognition functions (e.g., diagnosis of specific diseases) using a hybrid material in which a biomaterial is combined with a phosphorescence-based material. In addition, the present invention may increase the intensity of a target signal (e.g., a phosphorescence signal) by accumulating the detected target signal (or improve augmentation efficiency). In other words, the present invention may improve (i.e., increase) the signal-to-background ratio (SBR) for a time-gated image and improve (i.e., increase) the signal-to-noise ratio (SNR) for a spectrum. Accordingly, the present invention may obtain clear images (e.g., high-resolution images recognizable by the unaided eye) and accurate spectral information. Furthermore, the present invention may perform quantitative spectral analysis using the spectral information acquired through a spectrometer. Accordingly, the present invention may overcome the limitations (or problems) of conventional methods that failed to acquire spectral information.

As described above, the present invention has been described with reference to the embodiments illustrated in the drawings, but these embodiments are merely illustrative examples, and those skilled in the art to which the present invention pertains will clearly recognize that various modifications, changes, and equivalent other embodiments are possible without departing from the spirit and scope of the present invention. Therefore, the true scope of technical protection of the present invention should be determined by the technical spirit of the appended claims.

1. A system for analyzing a photoluminescence signal based on time-gating, the system comprising:
an optical microscope configured to magnify and observe a sample specimen using light;
a laser light source coupled to one side of a body of the optical microscope and configured to irradiate the sample specimen to be analyzed with a pulsed laser;
a detector configured to detect a photoluminescence signal of the sample specimen irradiated with the pulsed laser; and
a function generator connected to the laser light source and the detector, and configured to provide a first pulse signal to the laser light source and provide a second pulse signal delayed by a predetermined delay time from the first pulse signal to the detector.

2. The system according to claim 1, further comprising a spectrometer configured to separate the photoluminescence signal by wavelength, and record the spectrum of the separated wavelength-specific signal.

3. The system according to claim 1, wherein the photoluminescence signal comprises an autofluorescence signal, a fluorescence signal, and a phosphorescence signal of the sample specimen.

4. The system according to claim 3, wherein the detector generates a time-gated image based on a phosphorescence signal acquired during one cycle of the second pulse signal.

5. The system according to claim 4, wherein the detector accumulates the time-gated images generated in each cycle of the second pulse signal to generate an accumulated time-gated image.

6. The system according to claim 3, wherein the detector accumulates phosphorescence signals acquired in each cycle of the second pulse signal, and generates an accumulated time-gated image based on the accumulated phosphorescence signals.

7. The system according to claim 1, wherein the sample specimen comprises a hybrid material in which a phosphorescent light-emitting material and a biomaterial are fused.

8. The system according to claim 3, wherein the delay time is varied based on the lifetimes of the autofluorescence signal, the fluorescence signal, and the phosphorescence signal.

9. The system according to claim 8, wherein the delay time is greater than a value obtained by adding the larger of the lifetimes of the fluorescence signal and the autofluorescence signal to the pulse width of the first pulse signal, and is equal to or less than a value obtained by adding the lifetime of the phosphorescence signal to the pulse width of the first pulse signal.

10. A method for operating a time-gated analysis system, the method comprising:
irradiating a sample specimen with a pulsed laser based on a first pulse signal;
detecting a photoluminescence signal of the sample specimen irradiated with the pulsed laser based on a second pulse signal delayed by a predetermined delay time from the first pulse signal; and
generating a time-gated image based on the photoluminescence signal detected during one cycle of the second pulse signal.

11. The method according to claim 10, wherein the photoluminescence signal comprises an autofluorescence signal, a fluorescence signal, and a phosphorescence signal of the sample specimen.

12. The method according to claim 11, wherein the step of generating a time-gated image comprises accumulating time-gated images acquired in each cycle of the second pulse signal to generate an accumulated time-gated image.

13. The method according to claim 10, wherein the step of generating a time-gated image comprises accumulating phosphorescence signals acquired in each cycle of the second pulse signal and generating an accumulated time-gated image based on the accumulated phosphorescence signals.

14. The method according to claim 11, wherein the delay time is varied based on the lifetimes of the autofluorescence signal, the fluorescence signal, and the phosphorescence signal.

15. The method according to claim 14, wherein the delay time is greater than a value obtained by adding the larger of the lifetimes of the fluorescence signal and the autofluorescence signal to the pulse width of the first pulse signal, and is equal to or less than a value obtained by adding the lifetime of the phosphorescence signal to the pulse width of the first pulse signal.

16. The method according to claim 10, further comprising generating spectral information of the photoluminescence signal.
